(19) United States
(12) Patent Application Publication
(10) Pub. No.: US 2018/0183655 A1
(43) Pub. Date: Jun. 28, 2018

(54) RADIO FREQUENCY SHARING IN MULTI-SUBSCRIPTION WIRELESS COMMUNICATION DEVICE

(71) Applicant: QUALCOMM Incorporated, San Diego, CA (US)

(72) Inventors: Ashutosh Gupta, Hyderabad (IN); Harinath Reddy Patel, Mahabubnagar (IN); Amandeep Singh Bedi, Hyderabad (IN); Ankit Banaudha, Hyderabad (IN)

(21) Appl. No.: 15/391,650

(22) Filed: Dec. 27, 2016

(51) Int. Cl. H04L 12/24; H04L 29/06; H04L 12/26; H04W 76/04; H04B 1/3816; H04W 8/18; H04L 12/911

(52) U.S. Cl. CPC H04L 41/0668; H04L 65/1016; H04L 43/08; H04W 76/046; H04W 88/06; H04W 8/18; H04L 43/16; H04L 47/821; H04B 1/3816

(57) ABSTRACT

Embodiments described herein relate to systems and methods of managing communications for a wireless communication device having a first Subscriber Identity Module (SIM) associated with a first subscription and a second SIM associated with a second subscription. The method may include attempting a first activity by the first SIM with respect to a first network. The method may further include detecting a failure event of the first activity with respect to the first network. The method may further include identifying a time duration until performance of a reattempt of the first activity. The method may further include determining whether the identified time duration is greater than a threshold value. The method may further include, upon determining that the identified time duration is greater than the threshold value, performing a second activity by the second SIM with respect to a second network.

### BACKGROUND

A wireless communication device, such as a mobile phone device or a smart phone, may include two or more Subscriber Identity Modules (SIMs). Each SIM may enable at least one subscription via a Radio Access Technology (RAT). Such a wireless communication device may be a multi-SIM wireless communication device. In a Multi-SIM-Multi-Active (MSMA) wireless communication device (e.g., a Dual-SIM-Dual-Active (DSDA) device), all SIMs may be active at the same time. In a Multi-SIM-Multi-Standby (MSMS) wireless communication device (e.g., a Dual-SIM-Dual-Standby (DSDS) device), if any one SIM is active, then the rest of the SIM(s) may be in a standby mode. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network.

A DSDS wireless communication device may have two subscriptions. In this case, a first subscription (e.g., an LTE subscription) may be designated as a Default Data Subscription (DDS) for data services while a second subscription (e.g., also an LTE subscription) may be utilized for multimedia services such as Voice-Over-LTE (VoLTE) over an Internet Protocol (IP) Multimedia Subsystem (IMS), Video Technology (VT), or Short Messaging Services (SMS). Occasionally, an IMS subscription may fail in an attempt to perform an activity (e.g., a VoLTE call, registration, publish, etc.). As such, the wireless communication device may wait a period of time before reattempting the activity. However, in between these reattempts, the Radio Resource Control (RRC) connection of the IMS subscription remains intact, effectively locking the radio frequency (RF) chain of the wireless communication device such that tuning away to the other subscription (e.g., the DDS subscription) is blocked and activities of the other subscription cannot be performed.

### SUMMARY

Aspects described herein relate to managing communications for a first subscription and a second subscription in a Multi-SIM-Multi-Standby (MSMS) wireless communication device. The first and/or second subscription may be an Internet Protocol (IP) Multimedia Subsystem (IMS). The IMS may enable IMS services such as, but not limited to, Rich Communication Services (RCS), File To Protocol (FTP) services, video sharing services, Voice-Over-LTE (VoLTE), Video Technology (VT), Short Messaging Services (SMS), and/or the like. In some aspects, in the event of a failure of an activity of a first subscription, which is an IMS subscription (e.g., an IMS-only subscription), the wireless communication device may allow activities of a second subscription, which is a Default Data Subscription (DDS) (e.g., an IMS or a non-IMS subscription), to be performed during the time duration between the first attempt and a subsequent reattempt of the failed activity. In some aspects, in response to detecting the failure of the activity with respect to the IMS subscription, the wireless communication device releases the radio resource control (RRC) connection, for example, by releasing signaling radio bearers (SRB) and data radio bearers (DRB), with a network associated with the IMS subscription such that certain activities may be performed by the DDS subscription.

According to various aspects, there is provided a method of managing communications for a wireless communication device having a first Subscriber Identity Module (SIM) associated with a first subscription and a second SIM associated with a second subscription. The method includes attempting a first activity by the first SIM with respect to a first network. The method further includes detecting a failure event of the first activity with respect to the first network. The method further includes identifying a time duration until performance of a reattempt of the first activity. The method further includes determining whether the identified time duration is greater than a threshold value. The method further includes, upon determining that the identified time duration is greater than the threshold value, performing a second activity by the second SIM with respect to a second network.

In some aspects, first subscription of the first SIM is an IP Multimedia Subsystem (IMS) subscription.

In some aspects, the method further includes, upon determining that the identified time duration is greater than the threshold value, lowering a task and resource management (TRM) priority of the first activity such that a TRM priority of the second activity is higher than the TRM priority of the first activity.

In some aspects, a time period for performing the second activity is less than the identified time duration.

In some aspects, the second activity includes at least one of page decoding, channel maintenance, or background data transfer.

In some aspects, the first activity includes access signaling for at least one of IMS registration, rich communication service (RCS), short message service (SMS), or voice over Long-Term Evolution (VoLTE).

In some aspects, the method further includes, upon performing the second activity, reattempting the first activity by the first SIM with respect to the first network.

In some aspects, the threshold value is adjustable.

In some aspects, the threshold value is based on a data inactivity timer of the first network.

In some aspects, detecting the failure event of the first activity with respect to the first network includes a) receiving an error message in response to attempting the first activity, or b) receiving no response in response to attempting the first activity.

In some aspects, identifying the time duration until performance of the reattempt of the first activity includes a) identifying a time value of a Retry-After header field of the received error message, or b) identifying a default pattern for the reattempt received from the first network.

In some aspects, the method further includes locking, by the first SIM, a radio resource control (RRC) connection with the first network for attempting the first activity, and upon determining that the identified time duration is greater than the threshold value, releasing the RRC connection.

In some aspects, the threshold value is within a range of a data inactivity timer of the first network.

In some aspects, the method further includes waiting for a predetermined period upon detecting the failure event of the first activity before releasing the RRC connection.

In some aspects, the predetermined period corresponds to an estimate of a round trip time (RTT).

According to various aspects, a wireless communication device is provided. The wireless communication device includes at least one radio frequency (RF) resource, a memory, and a processor configured to connect to a first Subscriber Identity Module (SIM) associated with a first subscription and to a second SIM associated with a second subscription. The processor is further configured to attempt a first activity by the first SIM with respect to a first network. The processor is further configured to detect a failure event of the first activity with respect to the first network. The processor is further configured to identify a time duration until performance of a reattempt of the first activity. The processor is further configured to determine whether the identified time duration is greater than a threshold value. The processor is further configured to, upon determining that the identified time duration is greater than the threshold value, perform a second activity by the second SIM with respect to a second network.

In some aspects, the first subscription of the first SIM is an IP Multimedia Subsystem (IMS) subscription.

In some aspects, the processor is further configured to, upon determining that the identified time duration is greater than the threshold value, lower a task and resource management (TRM) priority of the first activity such that a TRM priority of the second activity is higher than the TRM priority of the first activity.

In some aspects, a time period for performing the second activity is less than the identified time duration.

In some aspects, the second activity includes at least one of page decoding, channel maintenance, or background data transfer.

In some aspects, the first activity includes access signaling for IMS registration, rich communication service (RCS), short message service (SMS), or voice over Long-Term Evolution (VoLTE).

In some aspects, the processor is further configured to, upon performing the second activity, reattempt the first activity by the first SIM with respect to the first network.

In some aspects, the threshold value is based on a data inactivity timer of the first network.

In some aspects, detecting the failure event of the first activity with respect to the first network includes a) receiving an error message in response to attempting the first activity, or b) receiving no response in response to attempting the first activity.

In some aspects, identifying the time duration until performance of the reattempt of the first activity includes a) identifying a time value of a Retry-After header field of the received error message, or b) identifying a default pattern for the reattempt received from the first network.

In some aspects, the processor is further configured to lock, by the first SIM, a radio resource control (RRC) connection with the first network for attempting the first activity; and upon determining that the identified time duration is greater than the threshold value, release the RRC connection.

In some aspects, the threshold value is within a range of a data inactivity timer of the first network.

In some aspects, the processor is further configured to wait for a predetermined period upon detecting the failure event of the first activity before releasing the RRC connection. According to various aspects, there is provided an apparatus for a wireless communication device having a first Subscriber Identity Module (SIM) associated with a first subscription and a second SIM associated with a second subscription to manage communications over the first subscription and the second subscription. The apparatus includes means for attempting a first activity by the first SIM with respect to a first network. The apparatus further includes means for detecting a failure event of the first activity with respect to the first network. The apparatus further includes means for identifying a time duration until performance of a reattempt of the first activity. The apparatus further includes means for determining whether the identified time duration is greater than a threshold value. The apparatus further includes, upon determining that the identified time duration is greater than the threshold value, means for performing a second activity by the second SIM with respect to a second network.

According to various aspects, there is provided a non-transient computer-readable medium including program instructions that, when executed, cause a computer to connect to a first Subscriber Identity Module (SIM) associated with a first subscription and to a second SIM associated with a second subscription; attempt a first activity by the first SIM with respect to a first network; detect a failure event of the first activity with respect to the first network; identify a time duration until performance of a reattempt of the first activity; determine whether the identified time duration is greater than a threshold value; and upon determining that the identified time duration is greater than the threshold value, perform a second activity by the second SIM with respect to a second network.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram of a communication system in accordance with various embodiments.

FIG. 2 is a component block diagram of an example of a wireless communication device according to various embodiments.

FIG. 3 is a process flowchart diagram illustrating an example of a communication management method according to various embodiments.

FIG. 4 is a process flowchart diagram illustrating an example of a communication management method according to various embodiments.

FIG. 5 is a process flowchart diagram illustrating an example of a communication management method according to various embodiments.

FIG. 6 is a component block diagram of a wireless communication device suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as a wireless communication device, User Equipment (UE), or Mobile Station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such a wireless communication device may include at least one Subscriber Identity Module (SIM), a programmable processor, memory, and circuitry for connecting to two or more mobile communication networks.

A wireless communication device may include one or more SIMs that provide users of the wireless communication devices with access to one or multiple separate mobile communication networks. The mobile communication networks may be supported by Radio Access Technologies (RATs). The wireless communication device may be configured to connect to one or more base stations via one or more RATs. Examples of RATs may include, but not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network. Each RAT may be associated with a subscription or SIM.

A wireless communication device provided with a plurality of SIMs and connected to two or more subscriptions or networks with one subscription or network being active at a given time is a Multi-SIM-Multi-Standby (MSMS) communication device. In one example, the MSMS communication device may be a Dual-SIM-Dual-Standby (DSDS) communication device, which may include two SIMs that may both be active on standby, but one is on standby when the other one is in use. In another example, the MSMS communication device may be a Triple-SIM-Triple-Standby (TSTS) communication device, which includes three SIMs that may all be active on standby, where two may be deactivated when the third one is in use. In other examples, the MSMS communication device may be other suitable multi-SIM communication devices, with, for example, four or more SIMs, such that when one is in use, the others may be deactivated.

On the other hand, a wireless communication device that includes a plurality of SIMs and connects to two or more subscriptions or networks with two or more subscriptions or networks being active at a given time may be an MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SIMs may remain active. In other examples, the MSMA communication device may be other suitable multi-SIM communication devices with four or more SIMs, all of which may be active.

Generally, embodiments described herein may be applicable to an MSMS wireless communication device having at least a first SIM and a second SIM. Illustrating with a non-limiting example, the first SIM may be associated with a first subscription via a first RAT, and the second SIM may be associated with a second subscription via a second RAT. In some embodiments, the first RAT and the second RAT may be the same. Illustrating with a non-limiting example, the first RAT and the second RAT may be LTE. The embodiments may also be applicable to an MSMA wireless communication device that halts first subscription communication activities when the second subscription receives pages or other types of communication due to blanking pattern, power back-off, interference, and/or the like.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless device on a network and enable communication services with the network. Because the information stored in a SIM may be the wireless device to establish a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters) stored in a particular SIM as the SIM and the communication network, as well as the services and RATs supported by that network, correlate to one another.

Embodiments described herein relate to intelligently scheduling communication for a wireless communication device having at least two subscriptions. The second subscription may be designated as an Internet Protocol (IP) Multimedia Subsystem (IMS) and the first subscription may be designated as DDS (e.g., may be designated LTE data). Given that the second subscription may be used for various IMS activities (e.g., VoLTE, VT, SMS, etc.), Radio Resource Control (RRC) of the wireless communication device may be locked during the performance of activities at the IMS subscription. For example, upon access signaling of one of the various IMS activities, the RF chain may be locked from then onwards. As an example of access signaling, the IMS core network of the second subscription may send Session Initiation Protocol (SIP) packets (or other types of communications) for VoLTE, VT, and SMS. The SIP is a protocol for signaling multimedia control sessions. The SIP packets associated with VoLTE, VT, and SMS may include INVITE and MESSAGE. INVITE is a request to establish a media session. MESSAGE is a request to or a response from the server supporting the IMS core network. Other activities of the IMS subscription include REGISTER, PUBLISH, and SUBSCRIBE. PUBLISH and SUBSCRIBE are for capability publishing and capability polling, respectively, by the wireless communication device.

Occasionally, an IMS subscription may fail in an attempt to perform an activity (e.g., a VoLTE call, registration, etc.). For example, in response to access signaling (e.g., sending a SIP invite) the wireless communication device may receive an error message or may not receive any response. As such, the wireless communication device may wait a period of time before reattempting the activity (e.g., reattempting the access signal). However, in between these reattempts, the RRC connection of the IMS subscription remains intact, effectively locking the RF chain of the wireless communication device such that tuning away to the other (e.g., DDS) subscription is blocked and activities of the non-IMS subscription cannot be performed. In some embodiments, in the event of a failure of an activity of the IMS subscription, the wireless communication device may allow activities of the other subscription (e.g., DDS) to be performed during the time duration between the first attempt and a subsequent reattempt of the failed activity.

Accordingly, embodiments described herein can increase data throughput for the first subscription (e.g., DDS subscription) and conserve resources of the wireless communication device and the network, which are otherwise wasted during the IMS inactivity period between communication attempts.

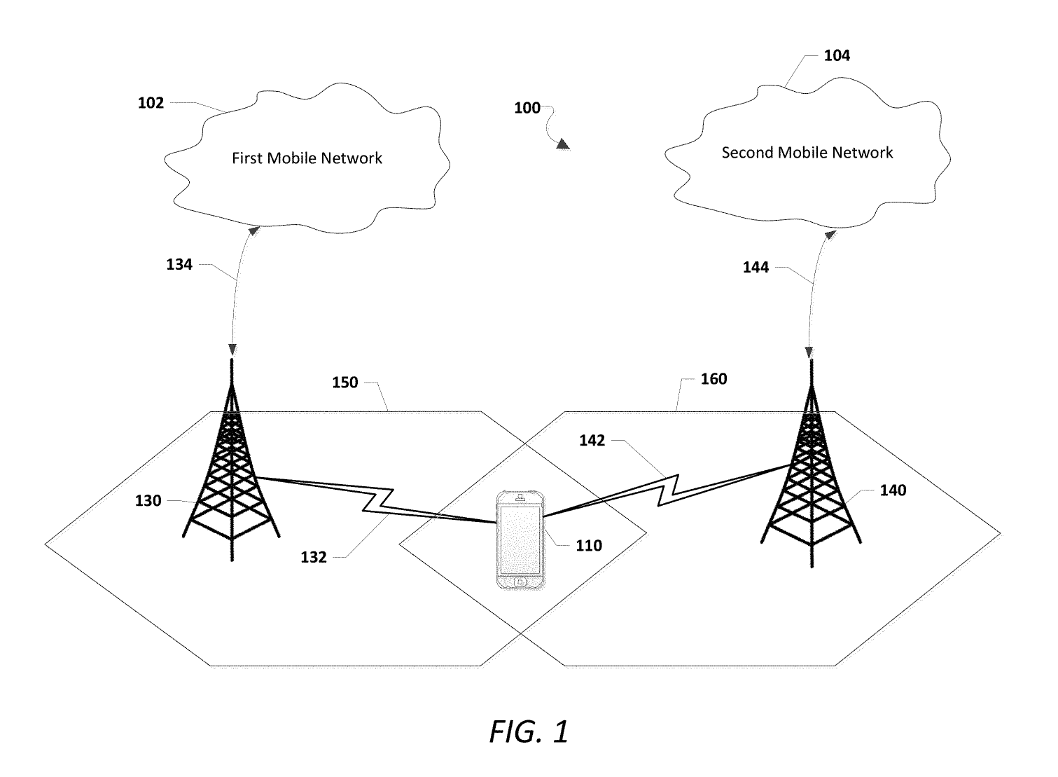

Various embodiments may be implemented within a communication system 100, an example of which is illustrated in FIG. 1. Referring to FIG. 1, a first mobile network 102 and a second mobile network 104 may each associate with a plurality of cellular base stations (e.g., a first base station 130 and a second base station 140, respectively). The first base station 130 may broadcast the first mobile network 102 in a first serving cell 150. The second base station 140 may broadcast the second mobile network 104 in a second serving cell 160. Illustrating with a non-limiting example, one or more of the first mobile network 102 and the second mobile network 104 may be associated with one or more of an IMS PDN, internet PDN, and/or the like. A wireless communication device 110 may be associated with (within effective boundaries of) both the first serving cell 150 and the second serving cell 160.

The wireless communication device 110 may be in communication with the first mobile network 102 through a first cellular connection 132 to the first base station 130. The first cellular connection 132 may correspond to the first RAT of the wireless communication device 110. The wireless communication device 110 may also be in communication with the second mobile network 104 through a second cellular connection 142 to the second base station 140. The second cellular connection 142 may correspond to the second RAT of the wireless communication device 110, as in a multi-SIM context. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enable by any suitable protocol including, but not limited to, FDMA, TDMA, CDMA (e.g., EVDO), UMTS (e.g., WCDMA, LTE, HSDPA, or the like), GSM, 1×, GPRS, Wi-Fi, PCS, and/or another protocol used in a wireless communications network or a data communications network. By way of illustrating with a non-limiting example, the first cellular connection 132 may be an LTE connection. The second cellular connection 142 may be an LTE connection. Other RATs (such as, but not limited to, WCDMA, HSDPA, EVDO, and the like) may be implemented in a similar manner. In some embodiments, the first cellular connection 132 and the second cellular connection 142 may be associated with a same RAT.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNodeB or eNB), base transceiver station (BTS), or the like.

In various embodiments, the wireless communication device 110 may be configured to access the first mobile network 102 and the second mobile network 104 by virtue of the multi-SIM and/or the multi-mode SIM configuration of the wireless communication device 110 (e.g., via the first cellular connection 132 and the second cellular connection 142). When a SIM corresponding to a RAT is inserted, the wireless communication device 110 may access the mobile communication network associated with that RAT based on the information stored on the SIM through registrations and call setups, as described herein.

While the wireless communication device 110 is shown connected to the mobile networks 102 and 104 via two cellular connections, in other embodiments (not shown), the wireless communication device 110 may establish additional network connections using at least one additional RAT.

In some embodiments, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”). In some embodiments, the wireless communication device 110 may establish a wireless connection with a wireless access point (not shown), such as over a Wi-Fi connection. The wireless access point may be configured to connect to the Internet or another network over a wired connection.

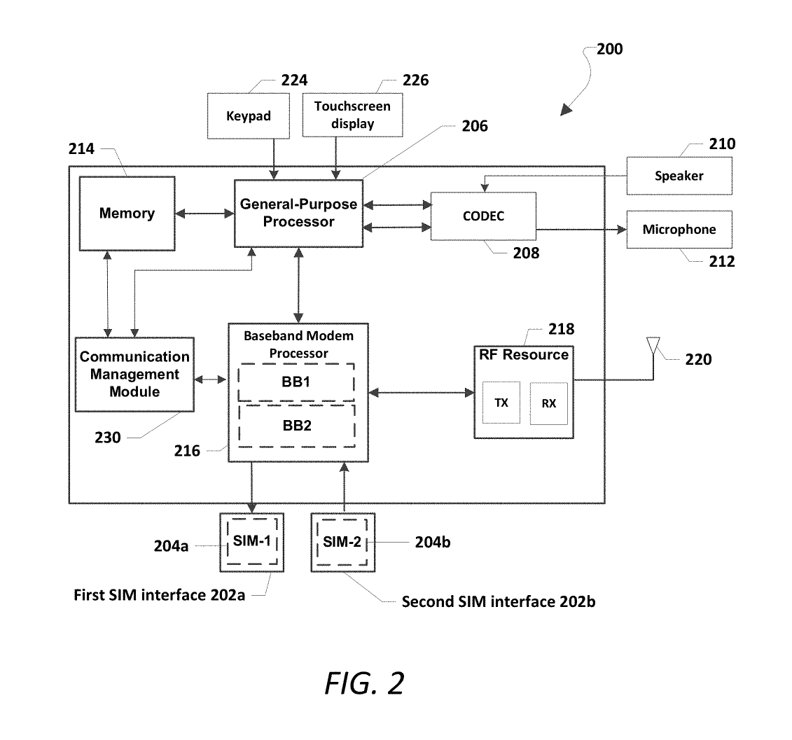

FIG. 2 is a functional block diagram of a wireless communication device 200 suitable for implementing various embodiments. According to various embodiments, the wireless communication device 200 may be the wireless communication device 110 as described with reference to FIG. 1. Referring to FIGS. 1-2, the wireless communication device 200 may include a first SIM interface 202a, which may receive a first identity module SIM-1 204a that is associated with the first mobile network 102. The wireless communication device 200 may also include a second SIM interface 202b, which may receive a second identity module SIM-2 204b that is associated with the second mobile network 104.

A SIM (e.g., SIM-1 204a, SIM-2 204b, and/or the like) in various embodiments may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. However, a SIM may be implemented within a portion of memory of the wireless communication device 200, and thus need not be a separate or removable circuit, chip, or card.

A SIM used in various embodiments may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may be a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but are not limited to, RAM, ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the SIM-1 204a, the SIM-2 204b, and/or the like) in the wireless communication device 200 may be associated with at least one baseband-RF resource chain. A baseband-RF resource chain may include the baseband modem processor 216, which may perform baseband/modem functions for communications on the SIMs. The baseband modem processor 216 may include one or more amplifiers and radios, referred to generally herein as a RF resource 218 or RF chain.

The embodiments described herein may be applicable to wireless communication devices in which the SIMs 204a and 204b share a common set of RF resource (particularly, the RF resource 218). Embodiments described herein may also be applicable to wireless communication devices in which each of the SIMs 204a and 204b has a separate RF resource, but activities of one of the SIMs 204a and 204b may be deactivated while the other one of the SIMs 204a and 204b is active.

The RF resource 218 may include at least one transceiver that perform transmit/receive functions for the associated SIMs 204a and 204b of the wireless communication device 200. The RF resource 218 may include separate transmit and receive circuitry, or may include a transceiver that combines transmitter and receiver functions. The RF resource 218 may be coupled to a wireless antenna 220. The RF resource 218 may also be coupled to the baseband modem processor 216.

In some embodiments, the general-purpose processor 206, the memory 214, the baseband modem processor 216, and the RF resource 218 may be included in the wireless communication device 200 as a system-on-chip. In some embodiments, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communication between them.

The wireless communication device 200 may include a communication management module 230. The communication management module 230 may configure the wireless communication device 200 to perform activities at the DDS subscription (e.g., the first subscription) in between reattempts of activities at the IMS subscription (e.g., the second subscription), as described herein.

In some embodiments, the communication management module 230 may be implemented within the general-purpose processor 206. For example, the communication management module 230 may be implemented as a software application stored within the memory 214 and executed by the general-purpose processor 206. Accordingly, such embodiments can be implemented with minimal additional hardware costs. However, other embodiments relate to systems and processes implemented with dedicated hardware specifically configured for performing operations described herein with respect to the communication management module 230. For example, the communication management module 230 may be implemented as a separate processing component (i.e., separate from the general-purpose processor 206). The communication management module 230 may be coupled to the memory 214, the general processor 206, the baseband processor 216, and/or the RF resource 218 for performing the function described herein.

Hardware and/or software for the functions may be incorporated in the wireless communication device 200 during manufacturing, for example, as a part of a configuration of an original equipment manufacturer (OEM) of the wireless communication device 200. In further embodiments, such hardware and/or software may be added to the wireless communication device 200 post-manufacture, such as by installing one or more hardware devices and/or software applications onto the wireless communication device 200.

In some embodiments, the wireless communication device 200 may include, among other things, additional SIM cards, SIM interfaces, at least another RF resource associated with the additional SIM cards, and additional antennas for connecting to additional mobile networks.

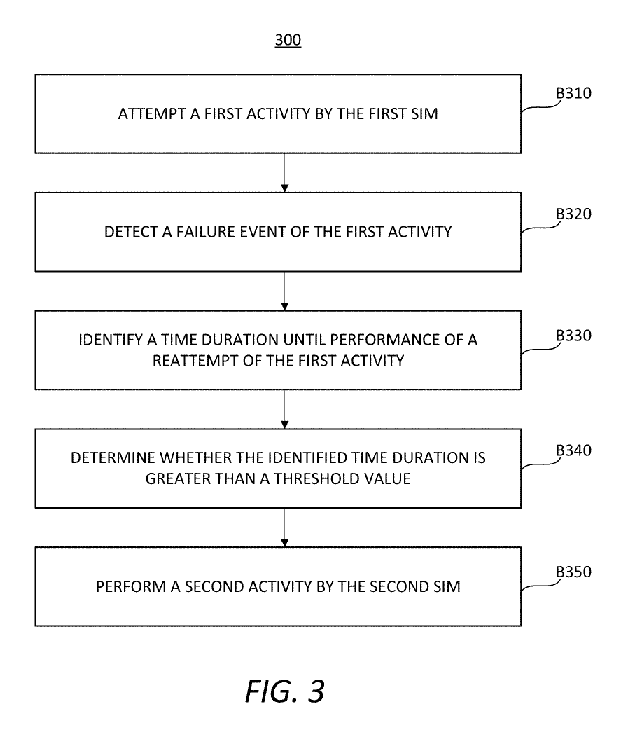

FIG. 3 is a process flowchart diagram illustrating an example of a communication management method 300 according to various embodiments. Referring to FIGS. 1-3, in some embodiments, at block B310 the communication management module 230 or the general-purpose processor 206 may attempt a first activity by a first SIM. The first SIM may be an IMS SIM and may be associate with SIM-1 204a or SIM-2 204b. In some embodiments, the activity may include an activity typically performed by an IMS subscription, such as, but not limited to, a VoLTE call, a video call, registration, SMS, RCS, or the like. The attempt may be with respect to a network associated with the IMS subscription (e.g., the first network 102 or the second network 104). The attempting of the first activity may include initially sending an access signal from the wireless communication device to the IMS network. The access signal may include an SIP message for signaling and controlling multimedia communication sessions.

At block B320, the communication management module 230 or the general-purpose processor 206 may detect a failure event of the first activity attempted at block B310. In some embodiments, the failure event includes one of receiving an error message from the network in response to the attempt or receiving no response from the network in response to the attempted activity.

At block B330, the communication management module 230 or the general-purpose processor 206 may identify a time duration until performance of a reattempt of the first activity. In some embodiments, the time duration is identified based on the type of failure detected at block B320. For example, in response to attempting the first activity, the wireless communication device may receive an error message from the network. The error message may include a Retry-After header field directing how much time the wireless communication device should wait before automatically reattempting the first activity. In some embodiments, the range of the Retry-After header field is from about 1 second to about 65535 seconds. In particular embodiments, the Retry-After header field is about 90 seconds. In other embodiments, in response to receiving an error message from the network, the wireless communication device is configured with a default reattempt scheme or pattern. For example, in response to attempting a PUBLISH or SUBSCRIBE activity for capability polling from the wireless communication device, the wireless communication device may perform subsequent reattempts of the activity at exponential time intervals (e.g., a first reattempt after waiting 1 minute, a second reattempt after waiting 2 minutes, a third reattempt after waiting 4 minutes, and so on).

In some embodiments, in response to attempting the first activity, the wireless communication device receives no response from the network. In particular embodiments, the wireless communication device is configured to follow default waiting procedures in response to receiving no response from the network. In some embodiments, the default waiting procedures may depend on the network or network carrier associated with the IMS subscription. The default waiting procedures may include set intervals or a pattern for waiting before reattempting the failed activity. For example, the wireless communication device may be configured to transmit re-requests at time intervals that double after every re-request until a timer expires. As an example, the initial time duration for waiting for a first re-request may be about 2 seconds to about 3 seconds. In the example of the initial time duration being 2 seconds, the second re-request may occur after 4 second, then again after 8 seconds, and then again after 16 seconds, and so on. In some embodiments, this waiting procedure pattern occurs until expiry of a timer. In some embodiments, the timer may be a multiple of the initial wait period after the first attempt (e.g., the timer may be 64, the multiple, times 2 seconds, the initial wait period). In other embodiments, any other suitable waiting procedure pattern is utilized at the wireless communication device (e.g., exponential time intervals of reattempts, and so on).

At block B340, the communication management module 230 or the general-purpose processor 206 may determine whether the identified time duration is greater than a threshold value. In some embodiments, the threshold value is a value stored on the wireless communication device, and that may be configurable or adjustable by a user or by the network. In some embodiments, the threshold value is set to a value such that that there is enough time during the identified time duration of block B330 to perform one or more activities at the second (DDS) subscription. For example, the threshold value may be set to a value of about 5 seconds to about 6 seconds.

In some embodiments, the threshold value is set based on a data inactivity timer of the network associated with the first subscription (e.g., the IMS subscription). For example, the threshold value may be set to being a fraction of the data inactivity timer. The data inactivity timer is a network-based timer that determines after how long of data inactivity the network will release the RRC connection from the wireless communication device. For example, the network may release the RRC connection from the wireless communication device after 10 seconds of data inactivity.

In some embodiments, at block B340, the communication management module 230 or the general-purpose processor 206 may determine whether the identified time duration is greater than or equal to the threshold value.

At block B350, the communication management module 230 or the general-purpose processor 206 may perform a second activity by the second (e.g., DDS) subscription, upon determining that the identified time duration is greater than a threshold value at block B340. Accordingly, the wireless communication device may determine that the second activity at the DDS subscription is performable within the waiting time duration before performance of a reattempt of the first activity, and the wireless communication device may therefore perform the second activity during the time duration that the wireless communication device is waiting to perform the reattempt of the first activity. In some embodiments, if the wireless communication device determines, at block B340, that the time duration identified in block B330 is less than (or equal to) the threshold value, then the wireless communication device may remain idle and wait until performance of the reattempt of the first activity by the IMS subscription.

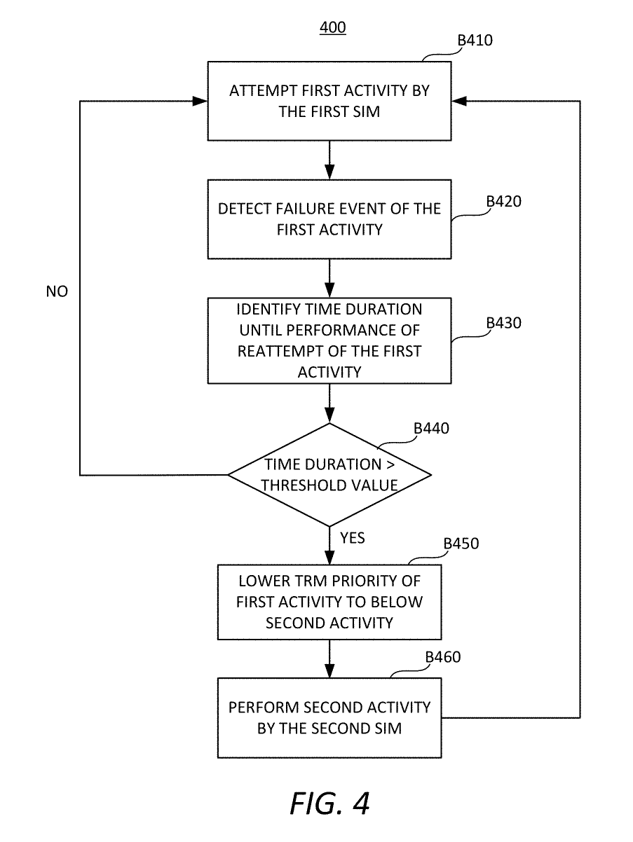

FIG. 4 is a process flowchart diagram illustrating an example of a communication management method 400 according to various embodiments. Referring to FIGS. 1-4, in some embodiments, at block B410, the communication management module 230 or the general-purpose processor 206 may attempt a first activity by the first subscription (e.g., the IMS subscription) in a manner such as, but not limited to, described with respect to block B310. At block B420, the communication management module 230 or the general-purpose processor 206 may detect a failure event of the first activity in a manner such as, but not limited to, described with respect to block B320. At block B430, the communication management module 230 or the general-purpose processor 206 may identify a time duration until performance of a reattempt of the first activity in a manner such as, but not limited to, described with respect to block B330.

At block B440, the communication management module 230 or the general-purpose processor 206 may determine whether the identified time duration is greater than a threshold value in a manner such as, but not limited to, described with respect to block B340. In response to determining that the identified time duration is less than (or equal to) the threshold value (B440: NO), the method 400 may return to block B410 for a reattempt of the first activity by the first subscription (e.g., the IMS subscription) after waiting for an amount of time indicated by the identified time duration.

At block B450, upon determining that the time duration is greater than the threshold value (B440: YES), the communication management module 230 or the general-purpose processor 206 may lower a Task and Resource Management (TRM) priority of the first activity to below than a TRM priority of a second activity to be performed by the DDS subscription. TRM priority may be assigned to one or more activities or tasks to be performed by the wireless communication device, and the wireless communication device may perform each task in the order of the respective TRM priorities. Conventionally, once the first activity is attempted (e.g., at block B410), and because the first activity is a significant IMS activity (e.g., voice call, IMS registration-related signaling, etc.), the wireless communication device assigns a highest TRM priority to the first activity. However, according to some embodiments, the TRM priority of the first activity may be lowered to allow performance of the second activity by the DDS subscription, while the IMS subscription would normally otherwise be idle for the time duration identified at block B430.

Accordingly, in some embodiments, by lowering the TRM priority of the first activity to below that of the second activity, the wireless communication device is able to perform the second activity despite the ongoing (but idle) first activity at the first or IMS subscription. In some embodiments, a time period for performing the second activity is less than the time duration identified at block B430. In particular embodiments, the time period for performing the second activity is less than the threshold value of block B440. In some embodiments, the TRM priority of the first activity is lowered below those of a plurality of second activities such that the combined time of the plurality of second activities is less than the identified time duration, and such that the wireless communication device performs the plurality of second activities.

In some embodiments, the one or more second activities include activities performed by the second (DDS) subscription that are relatively quick so as to be performed within the time window of the identified time duration. In some embodiments, the second activity performed by the second subscription includes, but is not limited to, page decoding, background data transfer, other channel maintenance activities, or the like. At block B460, the communication management module 230 or the general-purpose processor 206 may perform the second activity via the second (e.g., DDS) subscription. The second activity may be performed during the time duration identified at block B430. After performance of the second activity, the method 400 may return to block B410 in time for the scheduled reattempt of the first activity.

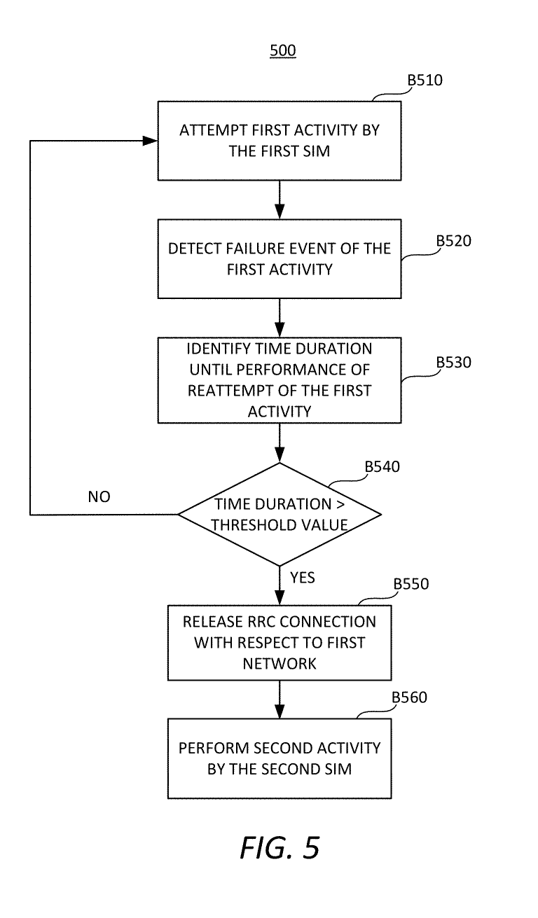

FIG. 5 is a process flowchart diagram illustrating an example of a communication management method 500 according to various embodiments. Referring to FIGS. 1-5, in some embodiments, one or more of blocks B510-B570 may correspond to one or more of blocks B310-B340 and/or blocks B410-B440.

In some embodiments, at block B510, the communication management module 230 or the general-purpose processor 206 may attempt a first activity by the first subscription (e.g., the IMS subscription) in a manner such as, but not limited to, described with respect to block B310. At block B520, the communication management module 230 or the general-purpose processor 206 may detect a failure event of the first activity in a manner such as, but not limited to, described with respect to block B320. At block B530, the communication management module 230 or the general-purpose processor 206 may identify a time duration until performance of a reattempt of the first activity in a manner such as, but not limited to, described with respect to block B330.

At block B540, the communication management module 230 or the general-purpose processor 206 may determine whether the identified time duration is greater than a threshold value in a manner such as, but not limited to, described with respect to block B340. In response to determining that the identified time duration is less than (or equal to) the threshold value (B540: NO), the method 500 may return to block B510 for a reattempt of the first activity by the first subscription (e.g., the IMS subscription) after waiting for an amount of time indicated by the identified time duration. In other embodiments, in response to determining that the identified time duration is less than (or equal to) the threshold value (B540: NO), the method 500 may proceed to block B450 of FIG. 4 and operate as described above in connection with block B450 and B460.

In some embodiments, the threshold value is within a range of a time value of a network data inactivity timer. For example, the threshold value may be greater than or less than the time value of the network data inactivity timer, for example, by a percentage of the time value of the network data inactivity timer (e.g., the threshold value may be greater than or less than the time value of the network data inactivity timer by about 20% (or less) of the time value of the data inactivity timer). In some embodiments, the threshold value equals (e.g., substantially equals) the time value of the network data inactivity timer. The data inactivity timer may be a time value upon which the network will release the RRC connection from the wireless communication device due to prolonged data inactivity for at least the duration of the time value.

At block B550, upon determining that the time duration is greater than the threshold value (B540: YES), the communication management module 230 or the general-purpose processor 206 may release the RRC connection with respect to the first network (or IMS network). Accordingly, the wireless communication device may sever the RRC connection on its own, instead of waiting for the network to sever the connection upon expiry of the data inactivity timer. As such, the wireless communication device can utilize its RF resources that would otherwise be locked by the first subscription in waiting to reattempt the first activity that would not even be performed due to the first network severing the RRC connection at the time of expiry of the data inactivity timer, since the time duration identified at block B530 is greater than the data inactivity timer.

In some embodiments, the wireless communication device may release the RRC connection after a predetermined period of time after determining that the time duration is greater than the threshold value (B540: YES). In particular embodiments, the predetermined period of time is the Round-Trip Time (RTT) of the wireless communication device. For example, the RTT of the wireless communication device may be in a range from about 2 seconds to about 3 seconds.

At block B560, the communication management module 230 or the general-purpose processor 206 may perform the second activity by the second subscription (e.g., the DDS subscription). Because the RRC connection of the first subscription is released at block B550, the RF resources of the wireless communication device is available to perform activities of the second subscription. As compared to the method 400, and because the RRC connection is completely released, the method 500 provides the ability for the second subscription to perform more time-intensive tasks, such as voice calls, as opposed to relatively quick tasks as described in connection with FIG. 4 during the idle waiting period between reattempts of the first subscription. Accordingly, once the second subscription is performing the second activity after the RRC of the first subscription is released, the default TRM prioritization of activities of the wireless communication device applies, and so the second subscription may maintain its own RRC connection even after the time duration before a reattempt of the first activity lapses.

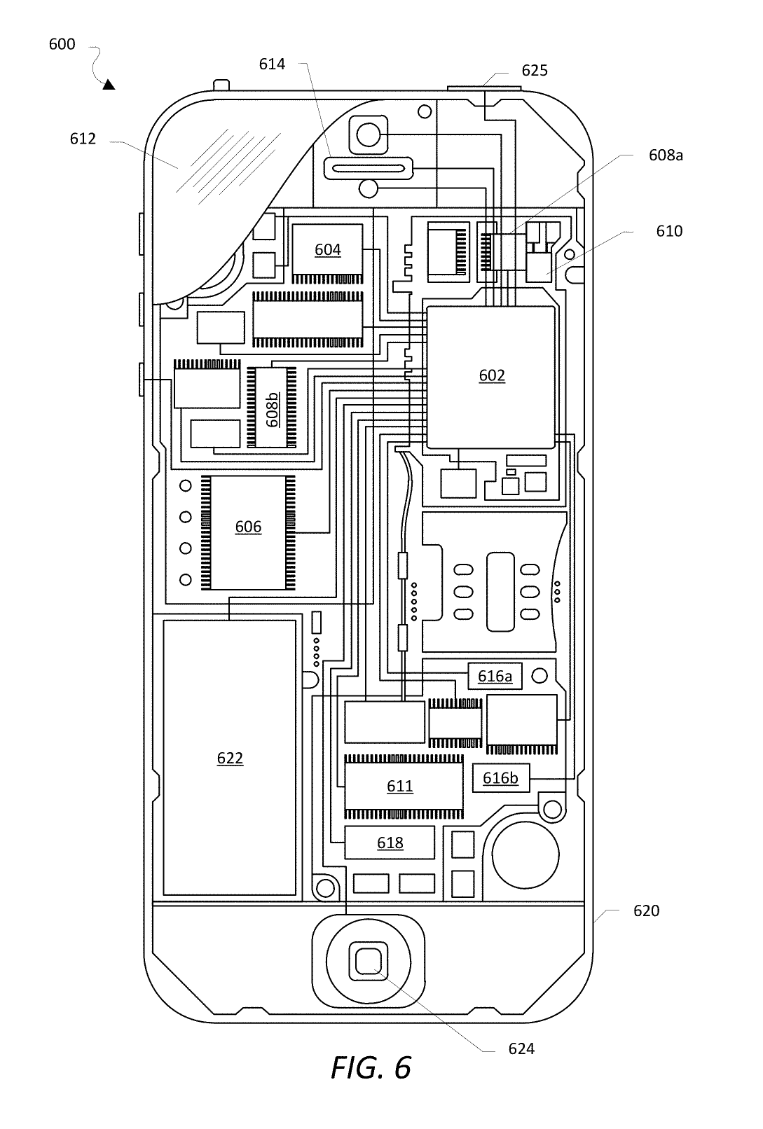

The various embodiments may be implemented in any of a variety of wireless communication devices 110 and 200, an example of which is illustrated in FIG. 6, as wireless communication device 600. As such, the wireless communication device 600 may implement the process and/or the apparatus of FIGS. 1-5, as described herein.

With reference to FIGS. 1-6, the wireless communication device 600 may include a processor 602 coupled to a touchscreen controller 604 and an internal memory 606. The processor 602 may be one or more multi-core integrated circuits designated for general or specific processing tasks. The memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the wireless communication device 600 need not have touch screen capability.

The wireless communication device 600 may have one or more cellular network transceivers 708a, 708b coupled to the processor 602 and to at least one antenna 610 and configured for sending and receiving cellular communications. The transceivers 608a, 608b and antenna 610 may be used with the above-mentioned circuitry to implement the various embodiment methods. The cellular network transceivers 608a, 608b may be the RF resource 218. The antenna 610 may be the antenna 220. The wireless communication device 600 may include two or more SIM cards 616a, 616b, corresponding to SIM-1 204a and SIM-2 204b, coupled to the transceivers 608a, 608b and/or the processor 602. The wireless communication device 600 may include a cellular network wireless modem chip 611 (e.g., the baseband modem processor 216) that enables communication via at least one cellular network and is coupled to the processor 602.

The wireless communication device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown).

The wireless communication device 600 may also include speakers 614 for providing audio outputs. The wireless communication device 600 may also include a housing 620, constructed of a plastic, metal, or a combination of materials, for containing all or some of the components discussed herein. The wireless communication device 600 may include a power source 622 coupled to the processor 602, such as a disposable or rechargeable battery. The rechargeable battery may also be coupled to a peripheral device connection port (not shown) to receive a charging current from a source external to the wireless communication device 600. The wireless communication device 600 may also include a physical button 624 for receiving user inputs. The wireless communication device 600 may also include a power button 626 for turning the wireless communication device 600 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the embodiments. Thus, the present embodiments are not intended to be limited to the embodiments shown herein but is to be accorded the widest scope consistent with the following claims and the principles and novel features disclosed herein.

What is claimed is:

1. A method of managing communications for a wireless communication device having a first Subscriber Identity Module (SIM) associated with a first subscription and a second SIM associated with a second subscription, the method comprising:
attempting a first activity by the first SIM with respect to a first network;
detecting a failure event of the first activity with respect to the first network;
identifying a time duration until performance of a reattempt of the first activity;
determining whether the identified time duration is greater than a threshold value; and
upon determining that the identified time duration is greater than the threshold value, performing a second activity by the second SIM with respect to a second network.

2. The method of claim 1, wherein the first subscription of the first SIM is an IP Multimedia Subsystem (IMS) subscription.

3. The method of claim 1, further comprising, upon determining that the identified time duration is greater than the threshold value, lowering a task and resource management (TRM) priority of the first activity such that a TRM priority of the second activity is higher than the TRM priority of the first activity.

4. The method of claim 3, wherein a time period for performing the second activity is less than the identified time duration.

5. The method of claim 3, wherein the second activity comprises at least one of page decoding, channel maintenance, or background data transfer.

6. The method of claim 1, wherein the first activity comprises access signaling for at least one of IMS registration, rich communication service (RCS), short message service (SMS), or voice over Long-Term Evolution (VoLTE).

7. The method of claim 1, further comprising, upon performing the second activity, reattempting the first activity by the first SIM with respect to the first network.

8. The method of claim 1, wherein the threshold value is adjustable.

9. The method of claim 1, wherein the threshold value is based on a data inactivity timer of the first network.

10. The method of claim 1, wherein detecting the failure event of the first activity with respect to the first network comprises a) receiving an error message in response to attempting the first activity, or b) receiving no response in response to attempting the first activity.

11. The method of claim 10, wherein identifying the time duration until performance of the reattempt of the first activity comprises a) identifying a time value of a Retry-After header field of the received error message, orb) identifying a default pattern for the reattempt received from the first network.

12. The method of claim 1, further comprising:
locking, by the first SIM, a radio resource control (RRC) connection with the first network for attempting the first activity; and
upon determining that the identified time duration is greater than the threshold value, releasing the RRC connection.

13. The method of claim 12, wherein the threshold value is within a range of a data inactivity timer of the first network.

14. The method of claim 13, further comprising waiting for a predetermined period upon detecting the failure event of the first activity before releasing the RRC connection.

15. The method of claim 14, wherein the predetermined period corresponds to an estimate of a round trip time (RTT).

16. A wireless communication device, comprising:
at least one radio frequency (RF) resource;
a memory; and
a processor configured to connect to a first Subscriber Identity Module (SIM) associated with a first subscription and to a second SIM associated with a second subscription, and further configured to:
attempt a first activity by the first SIM with respect to a first network;
detect a failure event of the first activity with respect to the first network;
identify a time duration until performance of a reattempt of the first activity;
determine whether the identified time duration is greater than a threshold value; and
upon determining that the identified time duration is greater than the threshold value, perform a second activity by the second SIM with respect to a second network.

17. The wireless communication device of claim 16, wherein the first subscription of the first SIM is an IP Multimedia Subsystem (IMS) subscription.

18. The wireless communication device of claim 16, wherein the processor is further configured to, upon determining that the identified time duration is greater than the threshold value, lower a task and resource management (TRM) priority of the first activity such that a TRM priority of the second activity is higher than the TRM priority of the first activity.

19. The wireless communication device of claim 18, wherein a time period for performing the second activity is less than the identified time duration.

20. The wireless communication device of claim 18, wherein the second activity comprises at least one of page decoding, channel maintenance, or background data transfer.

21. The wireless communication device of claim 16, wherein the first activity comprises access signaling for IMS registration, rich communication service (RCS), short message service (SMS), or voice over Long-Term Evolution (VoLTE).

22. The wireless communication device of claim 16, wherein the processor is further configured to, upon performing the second activity, reattempt the first activity by the first SIM with respect to the first network.

23. The wireless communication device of claim 16, wherein the threshold value is based on a data inactivity timer of the first network.

24. The wireless communication device of claim 16, wherein detecting the failure event of the first activity with respect to the first network comprises a) receiving an error message in response to attempting the first activity, or b) receiving no response in response to attempting the first activity.

25. The wireless communication device of claim 24, wherein identifying the time duration until performance of the reattempt of the first activity comprises a) identifying a time value of a Retry-After header field of the received error message, orb) identifying a default pattern for the reattempt received from the first network.

26. The wireless communication device of claim 16, wherein the processor is further configured to:
lock, by the first SIM, a radio resource control (RRC) connection with the first network for attempting the first activity; and
upon determining that the identified time duration is greater than the threshold value, release the RRC connection.

27. The wireless communication device of claim 26, wherein the threshold value is within a range of a data inactivity timer of the first network.

28. The wireless communication device of claim 27, wherein the processor is further configured to wait for a predetermined period upon detecting the failure event of the first activity before releasing the RRC connection.

29. An apparatus for a wireless communication device having a first Subscriber Identity Module (SIM) associated with a first subscription and a second SIM associated with a second subscription to manage communications over the first subscription and the second subscription, the apparatus comprising:
means for attempting a first activity by the first SIM with respect to a first network;
means for detecting a failure event of the first activity with respect to the first network;
means for identifying a time duration until performance of a reattempt of the first activity;
means for determining whether the identified time duration is greater than a threshold value; and
upon determining that the identified time duration is greater than the threshold value, means for performing a second activity by the second SIM with respect to a second network.

30. A non-transient computer-readable medium comprising program instructions that, when executed, cause a computer to:
connect to a first Subscriber Identity Module (SIM) associated with a first subscription and to a second SIM associated with a second subscription;
attempt a first activity by the first SIM with respect to a first network;
detect a failure event of the first activity with respect to the first network;
identify a time duration until performance of a reattempt of the first activity;
determine whether the identified time duration is greater than a threshold value; and
upon determining that the identified time duration is greater than the threshold value,
perform a second activity by the second SIM with respect to a second network.
